(19) United States
(12) Patent Application Publication
(10) Pub. No.: US 2020/0093071 A1
(43) Pub. Date: Mar. 26, 2020

(54) PLANT GROWING STRUCTURE

(71) Applicant: Jason Paul Field, Tucson, AZ (US)

(72) Inventor: Jason Paul Field, Tucson, AZ (US)

(21) Appl. No.: 16/138,795

(22) Filed: Sep. 21, 2018

(51) Int. Cl. A01G 9/24; A01M 17/00; A01C 23/02

(52) U.S. Cl. CPC A01G 9/24; A01C 23/027; A01M 17/00

(57) ABSTRACT

A plant growing structure (100) designed to enhance the root quality, quantity, and architecture of plants grown in plant containers or in the ground is constructed from a plurality of support walls (200). The plant growing structure (100) enhances air circulation to the plant root system (20) to increase root growth and plant productivity. Channels (230) within the support walls (200) are designed with physical structures and materials that be adapted to address issues with aeration, infiltration, drainage, soil structure, root growth, plant nutrient uptake, plant pests and diseases, growing medium moisture, and growing medium microbial content. A liquid permeable drain platform (900) controls the amount and duration of water storage in the growing medium (50). The liquid permeable drain platform (900) may be used as a standalone device or in conjunction with the plant growing structure (100).

### BACKGROUND OF THE INVENTION

### (1) Field of Invention

A plant growing structure for the cultivation of plants is presented, where the plant growing structure is adapted to address the current limitations of plant growth when planted in plant containers and in the ground. The plant growing structure can be adapted to address issues with aeration, infiltration, drainage, soil structure, root growth, plant nutrient uptake, plant pests and diseases, growing medium moisture, and growing medium microbial content.

### (2) Description of Related Art

(2)(a) Support Structure and Aeration

Plant containers are empty vessels designed to hold a growing medium in which plants grow. A growing medium (50) is a substance that provides anchoring or support for plant roots (22) through which the plant roots (22) grow and extract water and nutrients. A plant root system (20) is comprised of the plant roots (22) that provide water and nutrients to the plant (10). The growing medium (50) for use in plant containers is available in two basic forms: a soil medium (52) and a soilless medium (54). A soilless medium (54) consists of a base of organic materials such as compost, peat, coconut coir, or other organic materials, mixed with inorganic ingredients such as vermiculite and perlite. These plant containers are not integrated with the plant root system (20) and therefore function strictly as a storage vessel remaining detached from the plant (10) and the plant roots (22). These plant containers are typically cylindrical or rectangular and are available in a wide variety of sizes and geometric configurations. Plant containers function as empty vessels with no structures or plant support systems within the internal volume of the plant container.

The Gro Pro® Plant Warrior™ pot is the only known alternative container that manipulates the internal volume of a plant container; however, this design reduces the internal volume of the container by modifying the bottom so that it is concave inward instead of flat.

The Root Warrior™ (made by the Plant Warrior Company) is nearly identical in design to the Plant Warrior™ but functions as an insert to modify the bottom of a typical plant container. The patent pending cone technology design “allows oxygen to be drawn through the bottom of the container promoting healthier, stronger roots.” The cone technology design is inefficient at increasing aeration in plant containers because it is limited to utilizing atmospheric oxygen strictly from the bottom of the container. Most container bottoms typically have only a few small holes to allow excess water to drain, and unlike the upper portion of a plant container, they are not open to the atmosphere, resulting in less air circulation through the bottom of containers. In addition, the cone technology design is limited in spatial extent and only extends into a small fraction of the bottom central portion of the container, thereby providing no mechanism to promote air circulation throughout the entire internal volume of the container.

The Ups-A-Daisy® and the PlanTier Soil Saver (US 202050366144 A1) container inserts reduce the total volume of growing medium required for planting by providing a raised or elevated bottom within the container to support the weight of the plant and the growing medium. The container inserts have small aeration voids that allow water to drain and oxygen to circulate from the bottom. Neither of these container inserts have structures or features that extend into the internal volume of the raised-bottom container, thus providing no mechanism to improve aeration or drainage within the plant root zone and/or the root ball. The root ball is defined as the compact mass of roots and soil formed by a plant. The plant root zone is defined as the area of soil and oxygen surrounding the roots of a plant. The only difference between these two container inserts is that the PlanTier Soil Saver has adjustable dimensions to fit a range of container sizes, whereas the Ups-A-Daisy® is available only in a range of fixed dimensions. The design of these container inserts, as well as those of the Root Warrior™ and Plant Warrior™, decreases the total depth of the growing medium by reducing the internal volume of the container. Decreasing the depth of the growing medium will result in less gravitational drainage of water and will not improve drainage of the growing medium as these designs claim.

Apparatuses exist for hydroponic and aero-ponic systems that may include a trellis or lattice structure for supporting and suspending plant roots in containers (e.g., US Application 20070086397 A1, DE 202008017655 U1, DE 10200803020226 B4). However, the main function of these devices is to support roots in water-based and aero-ponic systems.

(2)(b) Root Growth

Plants grown in plant containers typically have a large fraction of circling and kinked roots concentrated along the outer perimeter of the root ball. Circling and kinked roots do not branch effectively after transplant from one plant container to another or when planted in the ground. Circling and kinked roots are less efficient at absorbing water and nutrients compared to a more fibrous root system with better vertical and lateral root development. Plant containers typically create poor quality root systems that limit plant growth and often cause prolonged transplant stress. Root systems grown in plant containers do not effectively utilize the container volume because there are no mechanisms to promote root growth in the central portion of the container, which accounts for the majority of the total container volume. There are alternative designs to traditional plant containers; however, these alternatives focus strictly on redesigning the configuration of the outer circumference of a typical plant container and do not provide mechanisms for increasing root growth in the central portion of the container, where problems of poor drainage and aeration are most severe.

Problems with standard methods extend beyond plant containers since the majority of plants grown in plant containers will ultimately be planted in the ground (e.g., raised beds, backyards, agricultural systems, urban landscaping, and afforestation). Standard methods for planting in the ground require excavation, planting, and backfilling. This approach destroys the soil structure and reduces infiltration, drainage, and aeration within the backfilled area, creating increased transplant stress and a less favorable environment for new root growth and development. Plant containers, including container inserts, cannot be used to facilitate planting in the ground because these devices cannot be utilized to improve soil structure, infiltration, drainage, or aeration after excavation and backfilling.

(2)(c) Moisture

The rates of soil evaporation and water use by plants in containers or in the ground is highly dynamic and results in the non-uniform distribution of soil moisture following watering such that the outer circumference of the root ball dries too rapidly while the center of the root ball typically remains too wet (in plant containers) or too dry (in the ground). Although devices exist for enhancing aeration and drainage in plant containers, the prior art does not include either methods or devices that increase aeration and drainage in the growing medium while also providing an additional water supply for the plant to utilize.

(2)(d) Fertilization and Pest Control

Current methods of fertilizer application include broadcasting, placement, foliar application, aerial application, injection into soil, and fertigation (application through irrigation water). The main disadvantages of these methods include: (i) excessive nutrient loss due to volatilization to the atmosphere, surface runoff, and leaching below the plant root zone; (ii) increased nutrient loss due to microbial uptake and adsorption to soil particles and soil organic matter, especially in locations where the concentration of plants roots is minimal; (iii) stimulation of weed growth and invasive plants; and (iv) high risk of environmental pollution such as increased greenhouse gas emissions (e.g., nitrous oxide) and eutrophication of riparian and aquatic systems. In addition, the rate of nutrient supply from time-release fertilizers is primarily dependent on soil moisture, and to a lesser extent, soil temperature and microbial populations; the amount of plant available fertilizer is not determined by the needs of the plant itself but rather by environmental factors. This is also true for the application of pesticides, including herbicides, insecticides and fungicides, all of which are applied directly to the soil environment or the plant foliage but not directly to the plant root system.

Traditional potting and planting methods do not allow for optimized root-to-nutrient contact, making plant fertilization inefficient. Time-release fertilizers are applied directly to the growing medium in either granular form or as fertilizer spikes. However, these methods result in low root-to-nutrient contact causing increased nutrient loss and potential nutrient deficiencies in plants, especially for low solubility nutrients such as phosphorous, iron, and zinc.

Another major disadvantage of traditional methods of fertilizer and pesticide application, including the application of time-release fertilizer, is the short longevity of these products once applied to the environment. Most time-release fertilizers and pesticides are only active in the soil environment for a period of several weeks to months, resulting in the need for multiple applications throughout the life-span of most plants. Multiple applications of fertilizer and pesticide can be time-consuming and costly and can increase the potential for environmental contamination. To resolve these issues, there exists a need for multi-annual fertilizers and pesticides that specifically target the plant root system and reduce nutrient loss and potential contamination of the environment.

The only multi-annual fertilizer currently available is the Nutri-Pak® product—one and three year time-release fertilizer packets. The Nutri-Pak® is a “sealed” micro-pore fertilizer packet that releases nutrients through the micro-pores at a slow rate no matter how much water passes through the growing medium. Although this method of fertilizer application offers some advantages over traditional methods including increased longevity in the soil environment and less nutrient loss due to leaching and surface runoff, there are several potential problems associated with the use of micro-pore fertilizer packets. These problems include: (i) low root-to-nutrient contact throughout the plant root system; (ii) the need to dig and place up to 18 Nutri-Pak® fertilizer packets around a single large plant or tree to provide adequate nutrients, a process that must be repeated once every one to three years; (iii) the potential to damage plant roots when digging and burying the micro-pore fertilizer packets; and (iv) excessive soil disturbance around targeted plants (e.g., method requires the application of more than 100 2 oz. micro-pore fertilizer packets to satisfy the nutrient requirement throughout the life-span of a large individual plant or tree).

Granular fertilizer applications can be mixed with the growing medium, placed on top as a dressing, or layered within the growing medium, but these methods do not place the fertilizer in direct contact with the plant roots. Fertilizer spikes and micro-pore fertilizer packets also result in low root-to-nutrient contact throughout the plant root system.

(2)(e) Microbial Populations

Although methods exist for inoculating growing medium with microbial populations such as beneficial bacteria and mycorrhizal fungi, these methods simply apply microbial inoculum directly to the growing medium. Soil microbial inoculants consist of bacterial and/or fungal spores, and in some cases live individual bacterial cells, either in solid or liquid formulation. The direct application of microbial inoculants to the growing medium is usually ineffective because the fate of microbial populations in soil depends primarily on the environment. This means that the direct application of microbial inoculants to the growing medium often has little effect on the microbial population because the most important deterministic environmental factors, such as aeration and readily available sources of organic carbon, remain unchanged. In addition, the use of soil microbial inoculants does not allow for direct point-source application of inoculum to the plant root system. Another limitation associated with the use of soil microbial inoculants is that they do not remain in direct contact with the plant root system following the application. Furthermore, microbial inoculants that are applied directly to the growing medium typically do not form mature microbial colonies due to one or more limiting physical or chemical properties of the soil environment. Traditional methods of applying soil microbial inoculants do not allow for the application of mature microbial colonies directly to the soil environment or plant root system.

### BRIEF SUMMARY OF THE INVENTION

A plant growing structure (100) designed to enhance the root quality, quantity, and architecture of plants grown in plant containers or in the ground is constructed from a plurality of support walls (200). The plant growing structure (100) increases plant productivity in the growing medium by: (i) increasing aeration, infiltration, and drainage throughout the rooting zone; (ii) improving soil structure and promoting vertical and horizontal root development; (iii) increasing total root biomass, especially fibrous roots; (iv) enhancing plant uptake of nutrients and water; (v) reducing the number of circling and kinked roots; (vi) increasing beneficial soil bacterial and fungal populations; and (vii) increasing plant resilience to pests and diseases.

### BRIEF DESCRIPTION OF THE SEVERAL VIEWS OF THE DRAWING

FIG. 1 is a perspective view of a standard shape structure (110), an embodiment of the plant growing structure (100). The support walls (200) are joined together so that the cross sectional shape of the planting volumes (250) of the standard shape structure (110) are hexagonal, and the planting volume (250) is that of a hexagonal prism.

FIG. 2 is a cross sectional view of a first standard shape structure (110) placed within a second standard shape structure (110). A plant (10) is placed within the first standard shape structure (110). The first standard shape structure (110) and the second standard shape structure (110) are placed within a plant container (30). The cross sectional shapes of the first standard shape structure (110) and the second standard shape structure (110) are square.

FIG. 3 is a cross sectional view of a first standard shape structure (110) placed within a second standard shape structure (110). The first standard shape structure (110) and the second standard shape structure (110) are placed within a plant container (30). A plant (10) is placed within the first standard shape structure (110). The plant roots (22) of the plant root system (20) of the plant (10) are placed within the planting volume (250) of the second standard shape structure (110) and the planting volume (250) of the first standard shape structure (110).

FIG. 4 is a cross sectional view of a standard lattice structure (120) placed within a plant container (30). The support walls (200) cross each other so that the cross sectional shape of the planting volume (250) of the standard lattice structure (120) is square. A growing medium (50) is contained within the planting volume (250).

FIG. 5 is a cross sectional view of a standard lattice structure (120) within a plant container (30). The support walls (200) are cross each other so that the cross sectional shape of the planting volume (250) of the standard lattice structure (120) is square. The plant roots (22) of the plant root system (20) are placed within the planting volume (250) of the standard lattice structure (120).

FIG. 6 is a perspective view of a standard lattice structure (12020), an embodiment of the plant growing structure (100). The support walls (200) cross each other so that the cross sectional shape of the planting volumes (250) of the standard lattice structure (12020) are square.

FIG. 7 shows an example of how a standard lattice structure (12020) may be joined. A first support wall (260) and a second support wall (270) are joined together with a third support wall (280) through the use of interlocking slots (204). A first interlocking slot (282) of the third support wall (280) is joined together with the first interlocking slot (262) of the first support wall (260). A second interlocking slot (284) of the third support wall (280) is joined together with the first interlocking slot (272) of the second support wall (270).

FIG. 8 shows the cross section of a double layer corrugated support wall (200) comprised of two outer layers (210) joined together by one corrugated inner layer (220).

FIG. 9 shows the cross section of a twin wall support wall (200) comprised of two outer layers (210) joined together by a plurality of inner layers (220). The inner layers (220) are perpendicular to the outer layers (210), creating square shaped channels (230).

FIG. 10 shows the cross section of a triple wall support wall (200) comprised of three outer layers (210) joined together by a plurality of inner layers (220). The inner layers (220) are perpendicular to the outer layers (210), creating square shaped channels (230). The channel surface (232) of a channel (230) is shown.

FIG. 11 shows a front view of a support wall (200) of an Aeration Structure (300). The support wall (200) has a plurality of aeration voids (310) located on the outer layer (220) of the support wall(200).

FIG. 12 shows a sectional view of the support wall (200) of FIG. 11 taken at the sectioning plane and in the direction indicated by section lines 12-12, showing a plurality of aeration channels (320). The inner layers (220) are perpendicular to the outer layers (210), creating square shaped channels (230).

FIG. 13 shows a sectional view of the support wall (200) of FIG. 12 taken at the sectioning plane and in the direction indicated by section lines 13-13, showing a plurality of aeration channels (320). The channel surfaces (232) of the aeration channels (320) have aeration voids (310). A cross section of the inner layers (220) of the support walls (200) is shown. Channel openings (234) are shown, including top channel openings (236) and bottom channel openings (238).

FIG. 14 shows the top view of a support wall (200) of a Biological Structure (400) with a substrate (410) layered over a plurality of channel surfaces (232) of biological channels (470) of a support wall (200).

FIG. 15 shows a sectional view of the support wall (200) of a Biological Structure (400) of FIG. 14 taken at the sectioning plane and in the direction indicated by section lines 15-15, showing a plurality of biological channels (470). The substrate (410) is mixed with microbial populations (430) and microbial colonies (43z). The channel surfaces (232) of the biological channels (470) also have aeration voids (310). The substrate (410) is made from gel, that is, it is a gel substrate (450). The gel substrate (450) has dual state gel properties, that is, it is a dual state gel substrate (460).

FIG. 16 shows the sectional view of the support wall (200) of FIG. 15 with nutrients (420) added to the substrate (410).

FIG. 17 shows the top view of a support wall (200) with a pesticide (510) layered over a plurality of channel surfaces (232) of pesticide channels (520) of a support wall (200).

FIG. 18 shows a sectional view of the support wall (200), showing a plurality of moisture channels (630). The channel surfaces (232) of the moisture channels (630) also have aeration voids (310). Liquid permeable drain plugs (610) are inserted into the bottom channel opening (238). Liquid (40) is stored in the moisture channels (630).

FIG. 19 shows a sectional view of the support wall (200), showing a plurality of moisture channels (630). Liquid absorbing materials (650) are contained within the moisture channels (630). The channel surfaces (232) of the moisture channels (630) also have aeration voids (310). Liquid permeable drain plugs (610) are inserted into the bottom channel opening (238). Liquid (40) is stored in the moisture channels (630).

FIG. 20 shows a sectional view of the support wall (200), showing a plurality of moisture channels (630). Liquid absorbing materials (650) are contained within the moisture channels (630). The channel surfaces (232) of the moisture channels (630) also have aeration voids (310). Liquid permeable drain plugs (610) are inserted into the bottom channel opening (238). Covers (660) seal the channel openings (234) that contain liquid absorbing materials (650).

FIG. 21 shows a sectional view of the support wall (200), showing a plurality of fertilizer channels (720). Solid fertilizer (714) is contained within some of the fertilizer channels (720). Liquid fertilizer (712) is contained within some of the fertilizer channels (720). Gel fertilizer (716), specifically dual state gel fertilizer (718), is contained within some of the fertilizer channels (720). Some channel surfaces (232) of the fertilizer channels (720) have aeration voids (310). Liquid permeable drain plugs (610) are inserted into the bottom channel opening (238). Non liquid-permeable plugs (612) are also inserted into the bottom channel openings (238). Covers (660) seal the channel openings (234) that contain solid fertilizer (714).

FIG. 22 is a cross sectional view of a standard lattice structure (200) within a plant container (30). The support walls (200) are cross each other so that the cross sectional shape of the planting volume (250) of the standard lattice structure (120) is square. The plant roots (22) of the plant root system (20) are placed within the planting volume (250) of the standard lattice structure (120). The multi-purpose structure (800) has aeration channels (320), moisture channels (630), fertilizer channels (720), and biological channels (470).

FIG. 23 shows a perspective exploded view of a liquid permeable drain platform (900) with a plurality of drain platform layers (910), comprising a first drain platform layer (912), a second drain platform layer (914), and a third drain platform layer (916).

FIG. 24 shows a top view of a liquid permeable drain platform (900), where a first drain platform sub-area (922) is surrounded by a second drain platform sub-area (924) and a third drain platform sub-area (926). The first drain platform sub-area (922), second drain platform sub-area (924) and the third drain platform sub-area are concentric, sharing the same center. The inner perimeter of the second drain platform sub-area (924) and the third drain platform sub-area (926) are square shaped.

FIG. 25 shows a sectional view of a liquid permeable drain platform (900) of FIG. 24 taken at the sectioning plane and in the direction indicated by section lines 25-25. The sectional view shows the first drain platform sub-area (922) surrounded by a second drain platform sub-area (924) and a third drain platform sub-area (926).

FIG. 26 shows a top view of a liquid permeable drain platform (900), where a first drain platform sub-area (922) is surrounded by a second drain platform sub-area (924) and a third drain platform sub-area (926). The first drain platform sub-area (922), second drain platform sub-area (924) and the third drain platform sub-area are concentric, sharing the same center. The inner perimeter of the second drain platform sub-area (924) and the third drain platform sub-area (926) are round shaped. The liquid permeable drain platform (900) is located under the plant growing structure (100).

FIG. 27 shows a perspective view of a liquid permeable drain platform (900), where a first drain platform sub-area (922) is surrounded by a second drain platform sub-area (924) and a third drain platform sub-area (926). The first drain platform sub-area (922), second drain platform sub-area (924) and the third drain platform sub-area are concentric, sharing the same center. The inner perimeter of the second drain platform sub-area (924) and the third drain platform sub-area (926) are round shaped.

### DETAILED DESCRIPTION OF THE INVENTION

A plant growing structure (100) designed to enhance the root quality, quantity, and architecture of plants grown in plant containers or in the ground is constructed from a plurality of support walls (200). The plant growing structure (100) increases plant productivity in the growing medium by (i) increasing aeration, infiltration, and drainage throughout the rooting zone; (ii) enhancing soil structure and promoting vertical and horizontal root development; (iii) increasing total root biomass, especially fibrous roots; (iv) enhancing plant uptake of nutrients and water; (v) reducing the number of circling and kinked roots; (vi) increasing soil bacterial and fungal populations; and (vii) increasing plant resilience to pests and diseases.

The plant growing structure (100) can be preferably designed either as a standard shape structure (110) or a standard lattice structure (200). Irregular shaped structures may also be made.

### (1) Standard Shape Structure

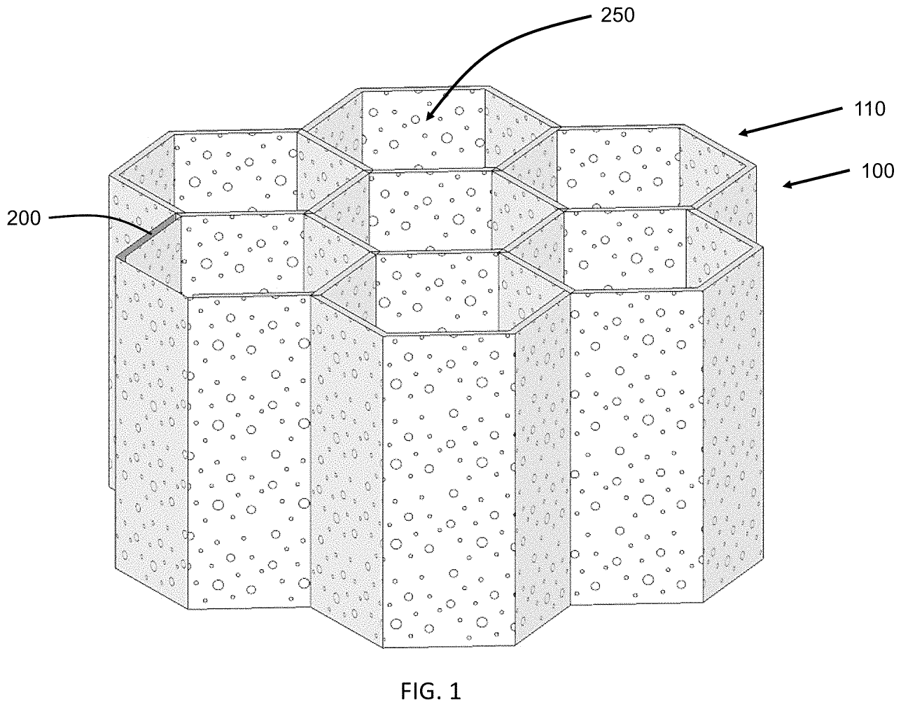

The standard shape structure (110) is comprised of a plurality of support walls (200). The support walls (200) are joined together to form three dimensional spaces within the support walls (200)—the planting volume (250). The planting volume (250) created by the joining of the support walls (200) may be in the shape of cubes, triangular prisms, rectangular prisms, and cylinders, among others. Plants (10) and their root systems (2020) are placed within the planting volume (250). The support walls (200) may be joined together to form more complex patterns such as hexagonal prisms and irregular shaped prisms. The support walls (200) may be joined together to form repeating patterns. FIG. 1 is a perspective view of a standard shape structure (110), an embodiment of the plant growing structure (100). The support walls (200) are joined together so that the cross sectional shape of the planting volumes (250) of the standard shape structure (110) are hexagonal, and the planting volume (250) is that of a hexagonal prism.

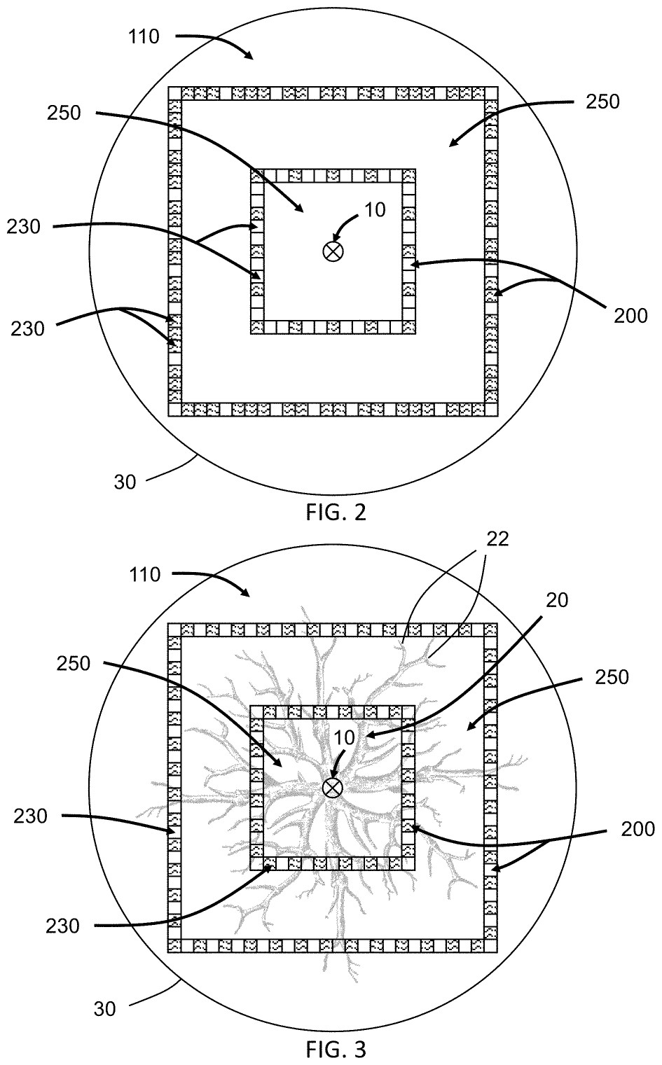

The overall dimensions of the standard shape structure (110) can vary in length, width, and height to accommodate plants (10) ranging in size from small grasses and forbs to large shrubs and trees. The standard shape structure (110) is designed to be placed in plant containers, to be planted directly into the ground, or to be used as a stand-alone structure. The standard shape structure (110) can also be placed within another standard shape structure (110), forming ring-like patterns. The plant roots (22) of the plant root system (20) of the plant (10) is placed within the planting volume (250) of the second standard shape structure (110) and the planting volume (250) of the first standard shape structure (110). FIG. 2 is a cross sectional view of a first standard shape structure (110) placed within a second standard shape structure (110). A plant (10) is placed within the first standard shape structure (110). The first standard shape structure (110) and the second standard shape structure (110) are placed within a plant container (30). The cross sectional shapes of the first standard shape structure (110) and the second standard shape structure (110) are square. FIG. 3 is a cross sectional view of a first standard shape structure (110) placed within a second standard shape structure (110). The first standard shape structure (110) and the second standard shape structure (110) are placed within a plant container (30). A plant (10) is placed within the first standard shape structure (110). The plant roots (22) of the plant root system (20) of the plant (10) are placed within the planting volume (250) of the second standard shape structure (110) and the planting volume (250) of the first standard shape structure (110).

### (2) Standard Lattice Structure

The standard lattice structure (120) is comprised of a plurality of support walls (200). The support walls (200) of a standard lattice structure (120) cross each other, forming regular and/or irregular planting volumes (250). Plants (10) and their root systems (200) are placed within the planting volumes (250). For example, the planting volumes (250) may have triangular or rectangular cross-sections. The support walls (200) may cross each other to form more complex shaped planting volumes (250). For example, the planting volume (250) may have hexagonal cross-sections.

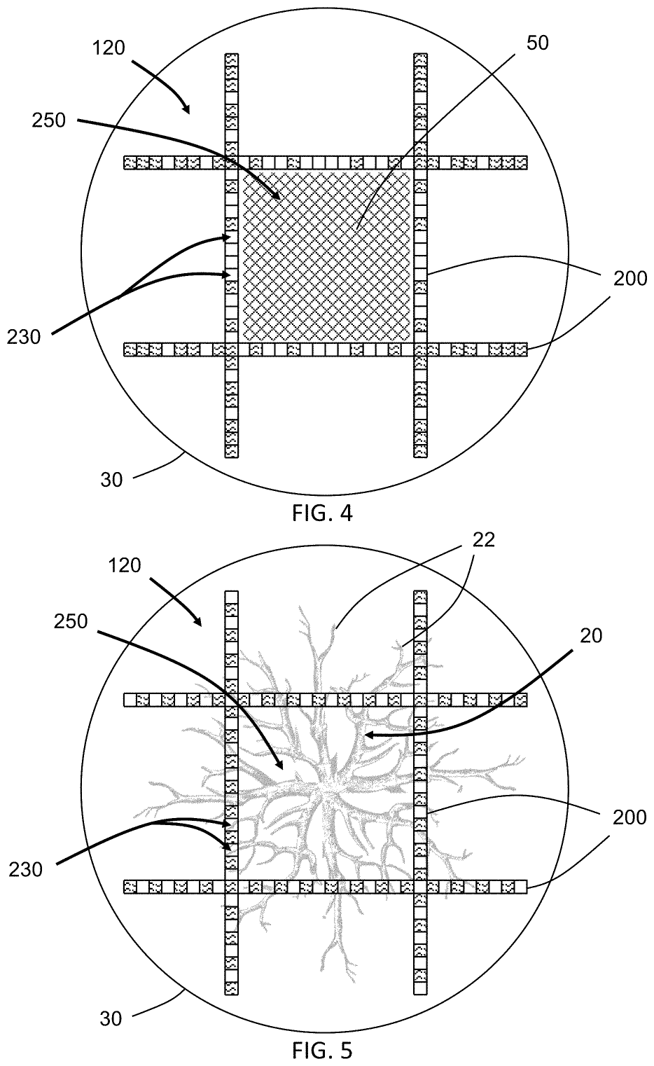

The overall dimensions of the standard lattice structure (120) can vary in length, width, and height to accommodate plants (10) ranging in size from small grasses and forbs to large shrubs and trees. The standard lattice structure (120) is designed to be placed within plant containers, to be planted in the ground, or to be used as a stand-alone structure. FIG. 4 is a cross sectional view of a standard lattice structure (120) placed within a plant container (30). The support walls (200) cross each other so that the cross sectional shape of the planting volume (250) of the standard lattice structure (120) is square. A growing medium (50) is contained within the planting volume (250).

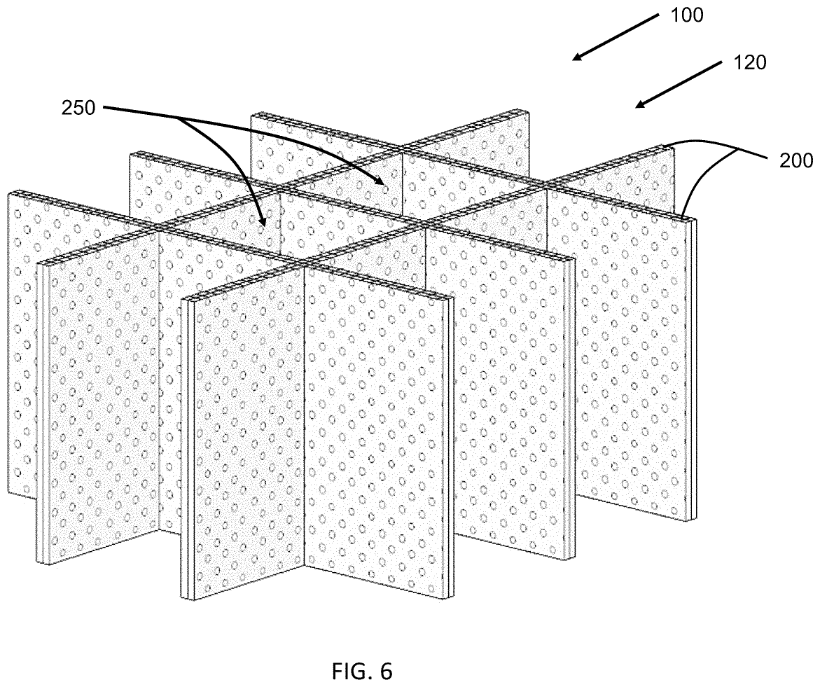

FIG. 5 is a cross sectional view of a standard lattice structure (120) within a plant container (30). The support walls (200) are cross each other so that the cross sectional shape of the planting volume (250) of the standard lattice structure (120) is square. The plant roots (22) of the plant root system (20) are placed within the planting volume (250) of the standard lattice structure (120). FIG. 6 is a perspective view of a standard lattice structure (120), an embodiment of the plant growing structure (100). The support walls (200) cross each other so that the cross sectional shape of the planting volumes (250) of the standard lattice structure (120) are square.

### (3) Support Walls

The support wall (200) is comprised of two or more outer layers (210). The outer layers (210) are substantially parallel to each other. The outer layers (210) are joined to each other by one or more inner layers (220). The inner layer (220) may be corrugated, that is, shaped into a series of alternate ridges and grooves. These alternate ridges and grooves may be arched, triangular, square, or any other state of the art shape. The traditional corrugated cardboard box support walls have arched inner layers (“flutes”). The spaces that are created when joining the outer layers (210) and the inner layer (220) are called channels (230). The surfaces that enclose a channel (230) are referred to as the channel surface (232). A channel (230) has a channel opening (234) at each end of the support wall (200): a top channel opening (236) and a bottom channel opening (238).

A first embodiment of the support wall (200) is comprised of two outer layers (210) joined together by a single corrugated arched inner layer (220), otherwise called double layer corrugated configuration or single wall. Additional outer layers (210) and inner layers (220) may be added; for example double wall and triple wall as defined in the cardboard industry. A second embodiment of the support wall (200) is comprised of two outer layers (210) joined together by two or more inner layers (220). The inner layers (220) may be perpendicular to the outer layers (210), creating rectangular or square channels (230), as seen from the top of the support wall (200). This is commonly called “twin wall” in the polycarbonate panel industry. The inner layers (220) may be angled (non-perpendicular) relative to the outer layers (210), creating trapezoidal or rhomboidal channels (230), as seen from the top of the support wall (200).

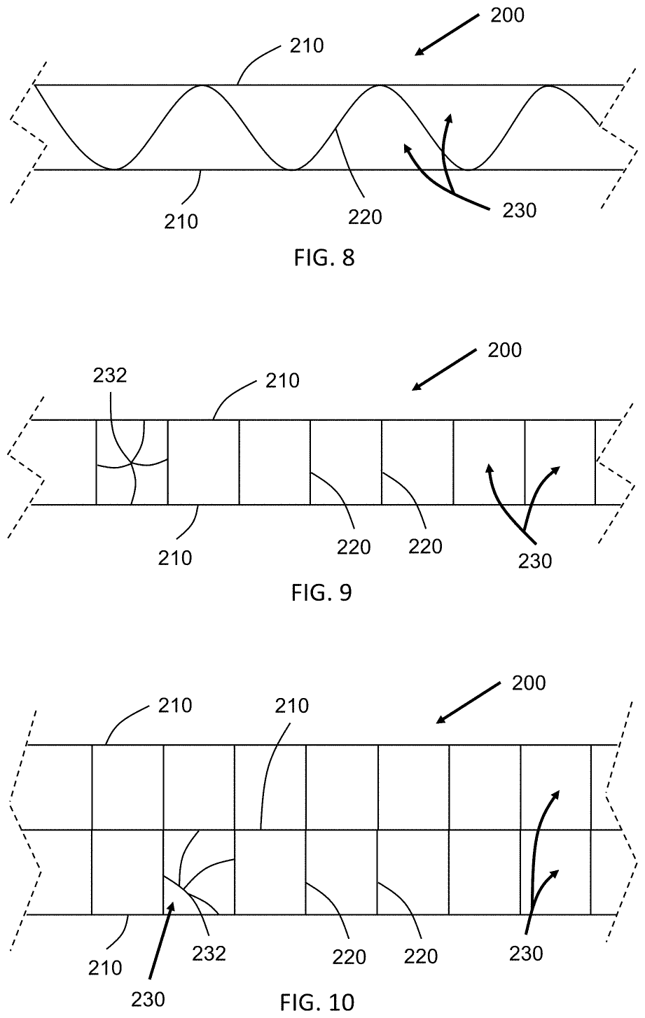

FIG. 8 shows the cross section of a double layer corrugated support wall (200) comprised of two outer layers (210) joined together by one corrugated inner layer (220). FIG. 9 shows the cross section of a twin wall support wall (200) comprised of two outer layers (210) joined together by a plurality of inner layers (220). The inner layers (220) are perpendicular to the outer layers (210), creating square shaped channels (230). FIG. 10 shows the cross section of a triple wall support wall (200) comprised of three outer layers (210) joined together by a plurality of inner layers (220). The inner layers (220) are perpendicular to the outer layers (210), creating square shaped channels (230). The channel surface (232) of a channel (230) is shown.

The surfaces of the outer layers (210) or the inner layers (220) or both may be smooth, or they may have a non-smooth profile such as rough, ribbed, plated, or corrugated. Such non-smooth profile increases total surface area for root growth and reduces the number of circling and kinked plant roots.

The outer layer (210) and the inner layer (220) may be made of materials that are porous or non-porous or both. The porosity of the outer layer (210) and the inner layer (220) is selected based on the function that the channels (230) will serve within the support wall (200). The selected porosity will determine the type of material used (e.g., plastic vs. porous cellulouse). The outer layer (210) and the inner layer (220) may be constructed out of a wide variety of porous materials or materials that can be altered to create adequate porosity. These materials can include but are not limited to plastics, fabrics, wood products, synthetic rubber, plant products, biodegradable polymers, sponge-like materials, nanomaterials, time-release fertilizer materials, processed rock phosphate, calcined clay, animal manure, and farm waste products.

The outer layer (210) and the inner layer (220) may be made of materials that are liquid permeable or impermeable (“non liquid-permeable”) or both.

The outer layer (210) and the inner layer (220) may be made of materials that are biodegradable or nutrient-rich or both. For example, when the outer layer (210) and the inner layer (220) are made of soluble and/or biodegradable nutrient-rich materials (e.g., rock phosphate, calcined manure), plant roots (22) will receive nutrient inputs as the plant growing structure (100) slowly decomposes and dissolves, and the degraded material becomes available for plant uptake in the growing medium (50), further enhancing plant growth and productivity. Overtime, the plant root system (20) of the plant (10) replaces the biodegradable plant growing structure (100) as new plant roots (22) grow and expand to occupy the voids created as the lattice decomposes and dissolves. The resulting vertical and lateral root structure and the large fibrous root mass of the mature plant works to maintain the improved physical properties of the growing medium (50) that were created by the presence of the plant growing structure (100) (e.g., improved soil structure, drainage, aeration).

For some materials, such as biodegradable polymers, the plant growing structure (100) can be designed to break down at different rates (for example, months to years) by selecting biodegradable polymer materials with different degradation characteristics.

The support walls (200) for the standard shape structure (110) and the standard lattice structure (120) may be joined together in a number of ways can include but are not limited to gluing, stapling, and melting, or any other state of the art method, depending on the support wall (200) material.

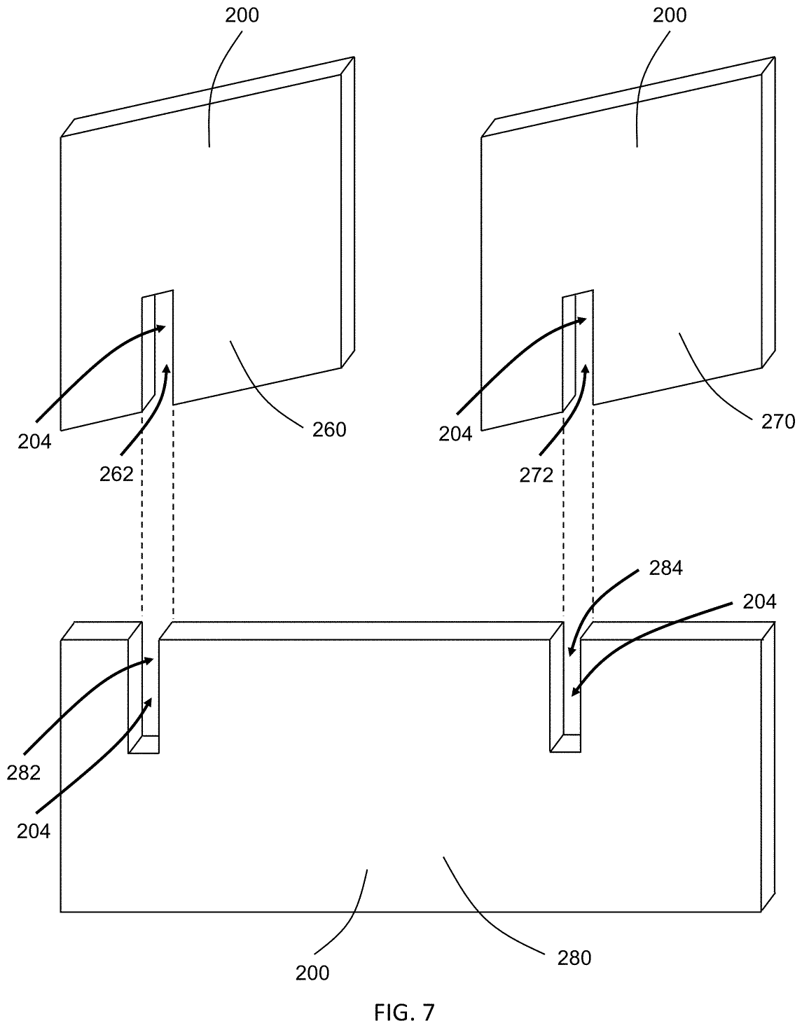

The support walls (200) of the standard lattice structure (120) may be joined through an interlock system. Support walls (200) are joined together by placing the interlocking slot (204) of one support wall (200) through the interlocking slot (204) of another support wall (200). The support wall (200) may have one or more interlocking slots (204). The interlocking slot (204) is a void across the width of the support wall (200). The ratio of the height of the interlocking slot (204) relative to the height of the support wall (200) is typically one half, but different other ratios can be utilized. FIG. 7 shows an example of how a standard lattice structure (120) may be joined. A first support wall (260) and a second support wall (270) are joined together with a third support wall (280) through the use of interlocking slots (204). A first interlocking slot (282) of the third support wall (280) is joined together with the first interlocking slot (262) of the first support wall (260). A second interlocking slot (284) of the third support wall (280) is joined together with the first interlocking slot (272) of the second support wall (270). Other methods for joining support walls (200) in a lattice structure configuration can include but are not limited to hooks, tongue and groove systems, dowels, brackets or any other state of the art method.

### (4) Aeration Structure

The Aeration Structure (300) is designed to provide enhanced air circulation to the plant root system (20) to increase root growth and plant productivity. An Aeration Structure (300) is prepared by adding one or more aeration voids (3010) to a channel surface (232) from the support walls (220) of a plant growing structure (100).

A channel (230) whose channel surface (232) has at least one aeration void (310) is called an aeration channel (320). There are one or more aeration channels (320) within an Aeration Structure (300). The aeration void ratio of a support wall (200) is calculated by dividing the total area of aeration voids (310) in a support wall (200) by the total surface area of the support walls (200). Aeration voids (310) allow plant roots (22) contained in the growing medium (50) within the planting volume (250) to grow through the support wall (200) into the aeration channels (3200) contained within the support wall (200). Aeration voids (310) are large enough to allow for the growth of plant roots (22) through these aeration voids (310). The plant roots (22) may continue to grow within the aeration channels (320) or may also grow through other aeration voids (310) into the growing medium (50) within the planting volume (250) or other type of channels—moisture channels (630), fertilizer channels (720), and biological channels (470).

Depending on the orientation of the Aeration Structure (300), a channel opening (234) may be in direct contact with the atmosphere. This allows air from the atmosphere to flow through the aeration channels (320) and the aeration voids (310), promoting air circulation throughout the growing medium (50) and the aeration channels (320). The aeration void ratio and the number of aeration voids (30) of the support wall (200) may be modified based on the variety of plants to be grown, the growing medium (50), and the growing environment (e.g. indoors, greenhouse, outdoors). The number, distribution, size, and geometry of the aeration voids (310) (e.g., circular voids vs. rectangular slits) may be modified to change the aeration void ratio of the support wall (200). The Aeration Structure (300) may have a fixed dimension or it can be expandable or adjustable to custom fit different-sized containers and excavations for planting in the ground.

In instances where fertilizer (710), pesticide (510), liquid (40), liquid absorbing materials (650), or substrate (410), or a combination thereof is present within channels (230) (see below), aeration voids (310) may also be present; the aeration voids (310) enable the plant roots (22) growth through the aeration voids (310) and to access and extract the fertilizer (710), pesticide (501) and liquid (40), stored within the channels (230) or layered over the channel surfaces (232) or both. The lack of aeration voids (310) extends the life of the fertilizer (710) or pesticide (510), stored within the channels (230) or layered over the channel surfaces (232) or both; the fertilizer (710) or pesticide (500) can only be accessed by the plant roots (22) after the support walls (200) begin to biodegrade in the growing medium—a process that takes several months to years depending on the type of material used.

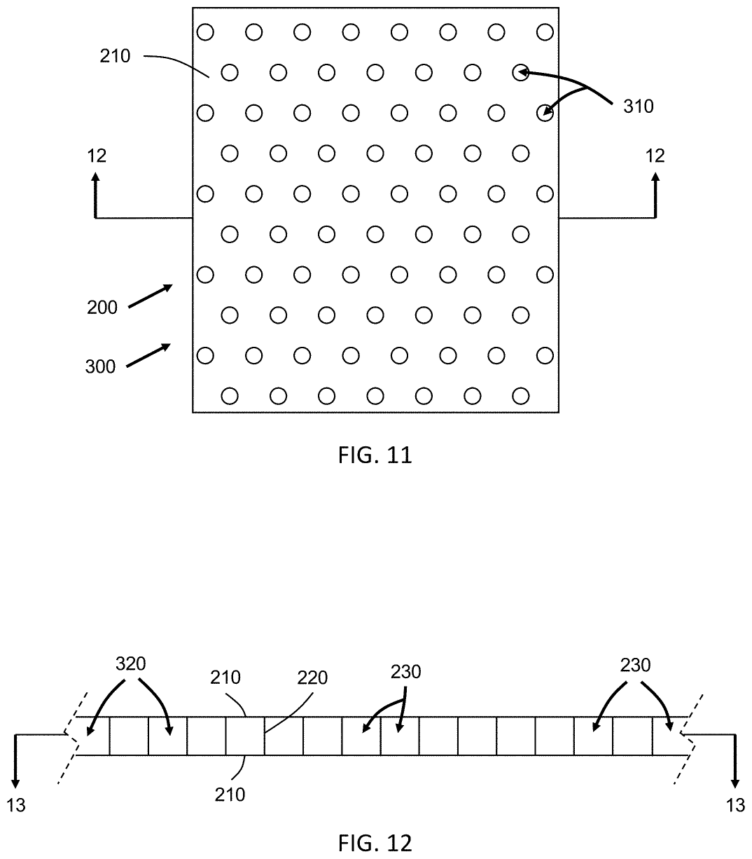

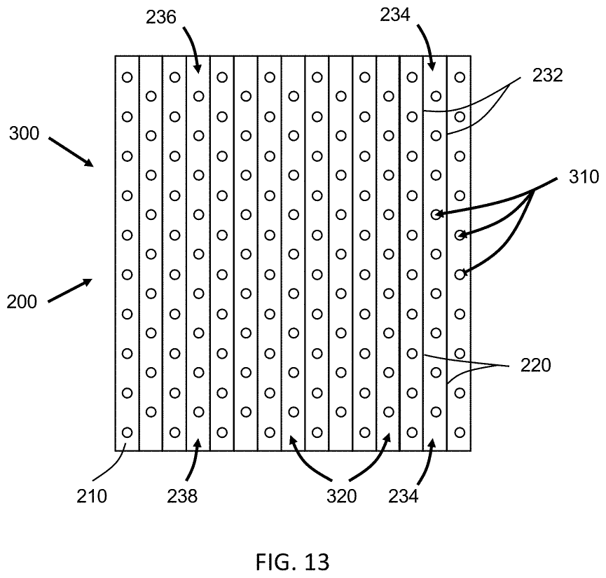

FIG. 11 shows a front view of a support wall (200) of an Aeration Structure (300). The support wall (200) has a plurality of aeration voids (310) located on the outer layer (220) of the support wall (200). FIG. 12 shows a sectional view of the support wall (200) of FIG. 1 taken at the sectioning plane and in the direction indicated by section lines 12-12, showing a plurality of aeration channels (320). The inner layers (220) are perpendicular to the outer layers (210), creating square shaped channels (230). FIG. 13 shows a sectional view of the support wall (200) of FIG. 12 taken at the sectioning plane and in the direction indicated by section lines 13-13, showing a plurality of aeration channels (320). The channel surfaces (232) of the aeration channels (320) have aeration voids (310). A cross section of the inner layers (220) of the support walls (200) is shown. Channel openings (234) are shown, including top channel openings (236) and bottom channel openings (238).

The Aeration Structure (300) is designed to function as an integral part of the plant root system providing several distinct advantages over traditional methods for growing plants in containers or in the ground. Plant containers, as well as container inserts, function to isolate root growth and development within the growing medium (50), making the plant (10) and the plant roots (22) a separate system not attached to the containers or inserts. The Aeration Structure (300) allows direct contact with the plant root system (20) and becomes physically attached to the plant root system (20) over time, making the plant (10) and its plant root system (20) inseparable from the Aeration Structure (300). The Aeration Structure (300) does not reduce container volume because it allows plant roots (22) to grow within the channels (230) and through the support walls (200) as facilitated by aeration voids (310), enabling plant roots (22) to utilize the entire container volume. When the growing tip of a plant root (22) encounters an aeration void (310) or an aeration channel (320) within the support walls (200), it is air pruned, forcing the plant root (22) to branch and develop a more fibrous plant root system (20).

If the Aeration Structure (300) is made from biodegradable materials (e.g. biodegradable polymers), the function of the Aeration Structure (300) would continue after the Aeration Structure (300) has biodegraded and broken down since the voids within the growing medium (50) that were created by the presence of the aeration channels (320) would remain intact.

### (5) Biological Structure

The Biological Structure (400) is designed to provide an ideal microbial environment to promote the rapid growth and proliferation of a microbial population (430) or a microbial colony (432) or both in plant containers or in the ground. Microbial populations (430) and microbial colonies (432) include beneficial bacterial and fungal organisms.

The Biological Structure (400) substantially increases microbial populations (430) and microbial colonies (432) in the growing medium (50) by providing a physically stable environment in the container or in the ground. The Biological Structure (400) also provides essential nutrients (including a readily available source of organic carbon) and oxygen, all of which are necessary to effectively increase microbial populations (430) in the growing medium (50).

The Biological Structure (400) is prepared by overlaying the channel surface (232) of a channel (230) of a support wall (200) with a layer of a substrate (410) mixed with a microbial population (430) or a microbial colony (432) or both. A substrate is material in which an organism lives, or the surface or medium on which an organism grows or is attached. The substrate (410) may be organic in nature, that is, pertaining to or derived from living organisms (plant, animal or fungus) that are produced or extracted without the use synthetic chemicals (any substance that is man-made by synthesis).

Nutrients (420) may be added to the substrate (410). Nutrients (420) are chemicals and elements that are utilized for bacterial growth and energy yielding processes; a substrate (410) with nutrients (420) serves as a long-term food source for the microbial population (430). Examples of nutrients (420) that may be added to the substrate (410) can include but are not limited to dipotassium phosphate, monopotassium phosphate, diammonium phosphate, magnesium sulfate, iron(II) sulfate, elemental sulfur, as well as beef extract, yeast extract, and peptons, which provide proteins and amino acids in addition to essential nutrients.

Nutrients (420) may include a readily available source of carbon such as glucose. This readily available source of carbon serves as the energy source for aerobic respiration. Most bacteria prefer to utilize glucose (monosaccharide) as their primary energy source because they possess the enzymes required for the degradation and oxidation of this sugar. Fewer bacteria are able to use complex carbohydrates like disaccharides (lactose or sucrose) or polysaccharides (starch).

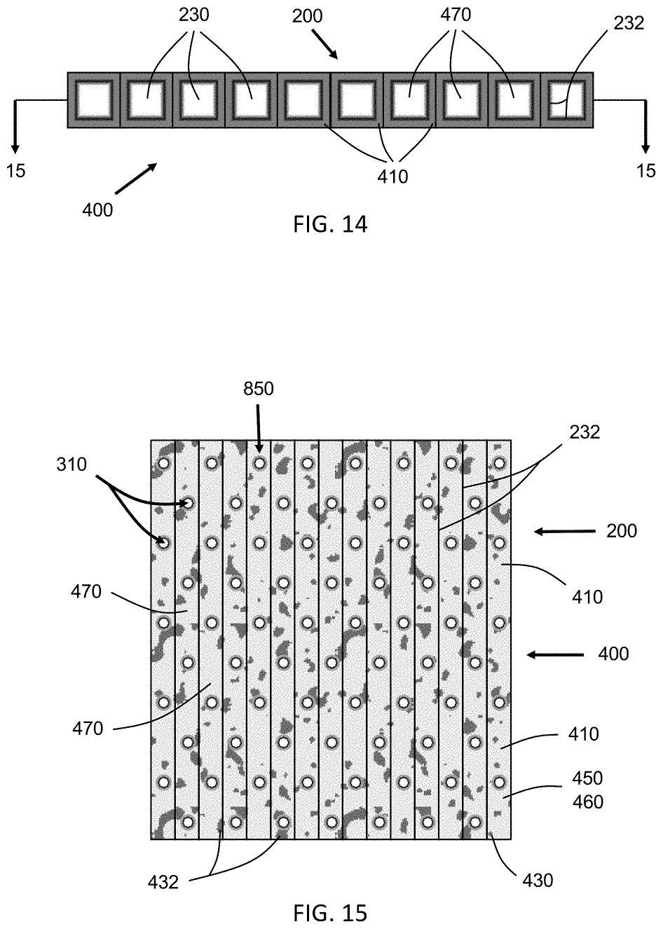

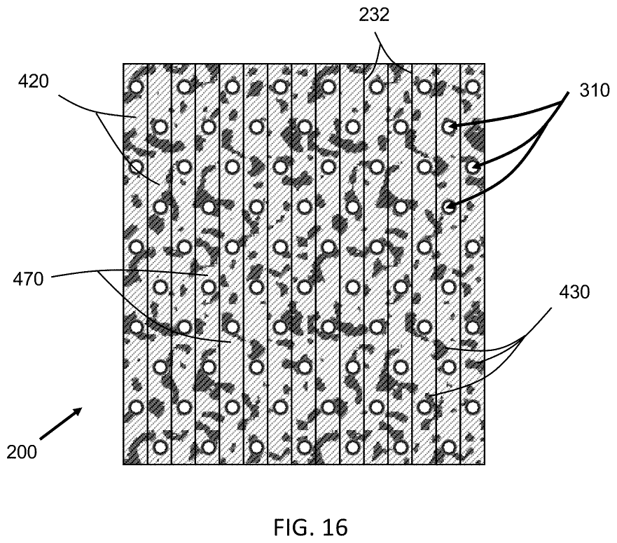

FIG. 14 shows the top view of a support wall (200) of a Biological Structure (400) with a substrate (410) layered over a plurality of channel surfaces (232) of biological channels (470) of a support wall (200). FIG. 15 shows a sectional view of the support wall (200) of a Biological Structure (400) of FIG. 14 taken at the sectioning plane and in the direction indicated by section lines 15-15, showing a plurality of biological channels (470). The substrate (410) is mixed with microbial populations (430) and microbial colonies (432). The channel surfaces (232) of the biological channels (470) also have aeration voids (310). The substrate (410) is made from gel, that is, it is a gel substrate (450). The gel substrate (450) has dual state gel properties, that is, it is a dual state gel substrate (460). FIG. 16 shows the sectional view of the support wall (200) of FIG. 15 with nutrients (4200) added to the substrate (410).

The substrate (410) may also contain a pH buffering solution (440) such as sodium bicarbonate or calcium carbonate. Optimizing the soil pH in the rooting zone can stimulate the growth and maintenance of beneficial bacterial populations, which are essential in converting organic nutrients (not available for plant uptake) to inorganic nutrients (available for plant uptake).

The substrate (410) can be a solid or a gel or both. When the substrate (410) is a gel, the gel substrate (450) is preferably solid-like at or near room temperature. The gel substrate (450) has minimal to no flow properties at or near room temperature, but when heated, the gel substrate (450) acquires liquid properties. A gel substrate (450) with these properties is called a dual state gel substrate (460). In a liquid state, the dual state gel substrate (460) can be flowed into the channels (230) of the support walls (200) and overlaid over the channel surfaces (232) as a thin coating. Once the temperature of the dual state gel substrate (460) is lowered, the dual state gel substrate (460) reverts to a solid-like state that remains in place. The properties of the dual state gel substrate (460) must be such that it can be easily poured when heated but reverts back to a solid state at temperatures below approximately 170° Fahrenheit to ensure the dual state gel substrate (460) remains within the plant growing structure (100) during shipping, transport, and storage. A channel (230) whose channel surface (232) has been layered over with a substrate (410) mixed with a microbial population (430) or a microbial colony (432) or both is called a biological channel (470). There are one or more biological channels (470) in a Biological Structure (400).

The substrate (410) is inoculated with a microbial population (430) that is beneficial to plant growth. Organisms composing the microbial population (430) are selected from free-living soil bacteria (e.g. cyanobacteria, actinomycetes, diazotrophic bacteria, rhizobia), mycorrhizal fungi (e.g. arbuscular mycorrhizas) or a blend of free-living soil bacteria and mycorrhizal fungi. This substrate (410) inoculated with the microbial population (430) is placed within the biological channels (470) immediately after inoculation. Microbial populations (432) include mycorrhizal fungal associations.

The substrate (410) inoculated with the microbial population (430) may also be incubated for an extended period of time to develop microbial colonies (432)—mature and stable bacterial and fungal populations—within the channels (230) prior to use. Microbial colonies (432) in the substrate (410) create symbiotic associations with plant roots (22), promote nutrient mineralization and availability in the growing medium (50), produce plant growth hormones, and increase plant resistance to pests and diseases. Microbial colonies (432) within the biological channels (470) are much more likely to quickly establish more effective symbiotic associations with the plant root system than traditional methods of inoculating the growing medium (50) with spores or individual bacterial cells. Microbial populations (430) in the growing medium (50) are key determinants of nutrient and organic matter cycling, soil fertility and health, plant productivity, and nutrient uptake.

By planting seeds or seedlings directly into a Biological Structure (400), the root system will be able to uptake nutrients and water more rapidly.

Mycorrhizal fungi form symbiotic relationships with more than 90% of all plant species and have been shown to substantially increase plant growth and yield by increasing the effective surface area of the plant root system. Mycorrhizae colonize the plant root system and enhance the ability of the plant to extract water and nutrients from the growing medium because the extensive hyphal network of the fungus functions as a natural extension of the plant root system, providing water and nutrients to the plant in exchange for carbon. Beneficial soil bacteria such as rhizobia, actinomycete, and endo-phytic bacteria also form symbiotic relationships with many plants, and in some cases, can change the morphology of the plant root system by increasing the number of root hairs. Some plants allocate more than half of their carbon reserves in the form of carbohydrates to mycorrhizae and other beneficial soil bacteria in exchange for increasing the effectiveness of the plant root system to extract water and essential nutrients from the growing medium. Mycorrhizal associations and beneficial soil bacteria have been shown to substantially increase plant growth and yield, up to 100% in some cases. Microbial colonies (432) provide additional benefits to plants including increased drought tolerance, enhanced resistance to adverse soil temperature and pH conditions, improved salinity tolerance, reduced stress after transplanting, and increased protection against plant pests and diseases.

### (6) Pesticide Structure

The Pesticide Structure (500) is designed to contain pesticides (510) for increased protection against plant pests and diseases.

A pesticide (510) is defined as:
a) any substance or mixture of substances intended for preventing, destroying, repelling, or mitigating any pest;
b) any substance or mixture of substances intended for use as a plant regulator, defoliant, or desiccant; or
c) any nitrogen stabilizer.

A pest is an organism under circumstances that make it deleterious to man or the environment, if it is:
a) any vertebrate animal other than man;
b) any invertebrate animal, including but not limited to, any insect, other arthropod, nematode, or mollusk such as a slug and snail, but excluding any internal parasite of living man or other living animals;
c) any plant growing where not wanted, including any moss, alga, liverwort, or other plant of any higher order, and any plant part such as a root; or
d) any fungus, bacterium, virus, prion, or other microorganism.

Examples of pesticides (510) include synthetic compounds such as systemics (e.g. imidacloprid, glyphosate) in either liquid or solid formulation.

Pesticides (510) may have natural and/or biodegradable qualities. Examples of natural and biodegradable pesticides (510) include potassium silicate and azadirachtin (neem oil).

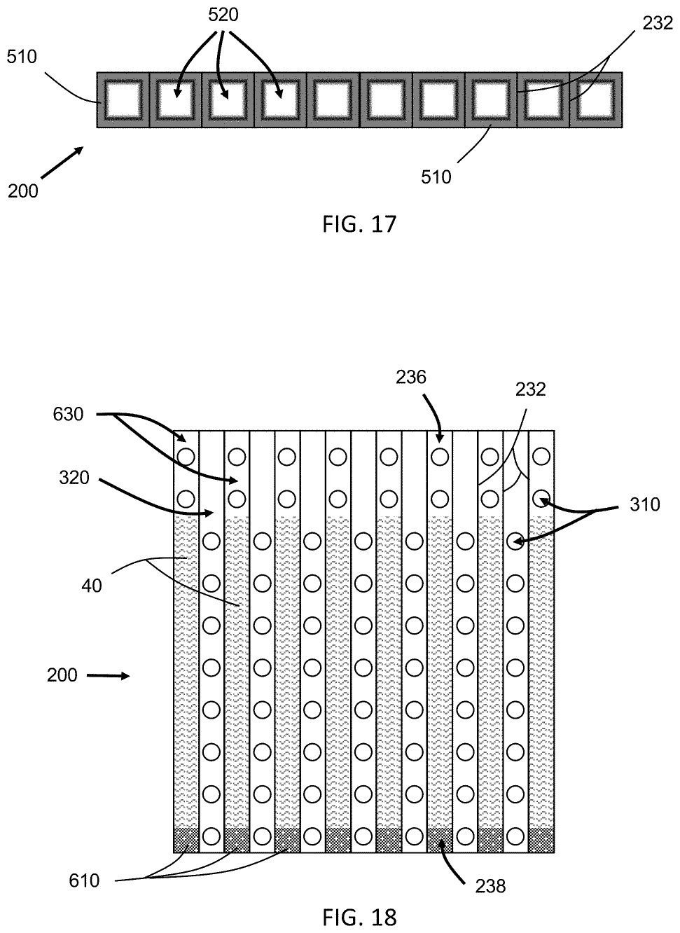

The Pesticide Structure (5 00) is prepared by adding pesticide (510) into a channel (230) of a support wall (200). A channel (230) that contains pesticide (510) is called a pesticide channel (520). There are one or more pesticide channels (520) within a Pesticide Structure (500). A pesticide channel (520) can be prepared by overlaying the channel surface (232) of a pesticide channel (502) with a layer of pesticide (510)—the pesticide (500) is layered over the channel surface (232). A pesticide channel (520) may also be prepared by adding powder or granular formulation of pesticide (50) to a channel (230). When the pesticide (510) is in a solid state, for example, powder or granular, the pesticide is held in place by a physical barrier, such as a liquid permeable structure (605) or a non liquid-permeable plug (612). Sample materials suitable for a non liquid-permeable plug (612) include silicone and rubber. FIG. 17 shows the top view of a support wall (200) with a pesticide (501) overlaying a plurality of channel surfaces (232) of pesticide channels (520) of a support wall (200).

### (7) Moisture Structure

The Moisture Structure (600) is designed to enhance aeration and drainage in plant containers and in the ground while also providing long-term water storage for the plant to utilize as the growing medium (50) begins to dry. Rates of soil evaporation and water use by plants in plant containers and in the ground are highly dynamic; traditional watering techniques result in the non-uniform distribution of soil moisture following watering such that the outer circumference of the root ball dries too rapidly while the center of the root ball typically remains too wet (in containers) or too dry (in the ground).

The Moisture Structure (600) optimizes soil moisture content throughout the plant rooting zone by providing one or more channels (230) within a support wall (200) with the capability to contain liquid (40) and to control the flow of liquid (40) into the growing medium (50). A channel (230) that has the capability to contain liquid (40) and to control the liquid flow into the growing medium (50) is called a moisture channel (630). A Moisture Structure (600) is comprised of one or more moisture channels (630).

Liquid (40) may be contained within the moisture channels (630) by utilizing liquid permeable structures (605) that control liquid flow from the moisture channels (630) into the growing medium (50). The liquid permeable structures (605) may be in the form of liquid permeable drain plugs (610) or a liquid permeable drain platform (900) or both.

Liquid (40) is preferably water or a water mixture. However, non-water based liquid (40) may also be utilized within the Moisture Structure (600).

(7)(a) Liquid Permeable Drain Plugs

Liquid permeable drain plugs (610) may be inserted into channel openings (234) that face the growing medium (50), typically the bottom channel openings (238). The liquid permeable drain plug (610) will control liquid flow from the moisture channel (630) into the growing medium (50). FIG. 18 shows a sectional view of the support wall (200), showing a plurality of moisture channels (630). The channel surfaces (232) of the moisture channels (630) also have aeration voids (310). Liquid permeable drain plugs (600) are inserted into the bottom channel openings (238). Liquid (40) is stored within the moisture channels (630).

Moisture channels (630) typically have channel surfaces (232) with liquid impermeable properties. However, channel surfaces may have liquid permeable properties to create other methods to provide moisture to the growing medium (50). Moisture channels (630) are positioned throughout the support walls (200) to solve plant moisture and watering issues. For instance, the Moisture Structure (600) can be designed to prevent the center of the root ball from becoming too wet or too dry by increasing the relative number and positioning of moisture channels (630) and aeration channels (320) towards the center of the root ball. The Moisture Structure (600) can be designed to prevent the outer circumference of the root ball from becoming too dry by increasing the number of moisture channels (630) near the perimeter of the root ball. The liquid permeable drain plug (610) can be designed to control liquid flow within the moisture channel (630) into the growing medium (50) for a range of times from minutes to hours up to several days or weeks following watering. This is achieved by selecting one or more types of liquid permeable materials with liquid permeability characteristics that allow for a preferred liquid flow rate. For example, liquid permeability characteristics can be adjusted by changing the combination of clay mixed with sand. The liquid flow rate from the moisture channels (630) to the growing medium (50) can be controlled by adjusting the amount and type of clay and sand, as well as the thickness of the liquid permeable drain plug (610) itself.

The liquid permeable drain plugs (610) may be made from a clay paste (620) prepared from a specific combination of different types of clay (e.g. kaolinite, vermiculite, montmorillonite) that can be mixed with fine to coarse sand in variable quantities to acquire the desired plasticity and water storage capability. After preparing a clay paste (620) of a specific composition and consistency, the liquid permeable drain plugs (610) are inserted into some of the channel openings (234)—the top channel openings (236) or the bottom channel openings (238)—by hand-packing the clay paste (620) or by dipping the Moisture Structure (600) into a clay paste reservoir (640) containing the clay paste (620). The thickness of the liquid permeable drain plugs (610) can be set by adjusting the depth of the clay paste (620) in the clay paste reservoir (640) or by hand-packing the clay paste to the desired thickness.

The ability of the moisture channels (630) to store liquid (40) can be substantially extended by the addition of liquid absorbing materials (650) within the moisture channels (630). These liquid absorbing materials (650) release their absorbed liquid after the height of the free-standing liquid within the moisture channel (630) drains below the liquid absorbing materials (650). The liquid absorbing materials (650) near the top opening of the moisture channels (630) start to release their liquid when the moisture channel (630) is approximately half filled with liquid (40); liquid absorbing materials (650) near the bottom channel openings (238) do not release their liquid (40) until essentially all of the liquid has drained out through the liquid permeable drain plugs (610).

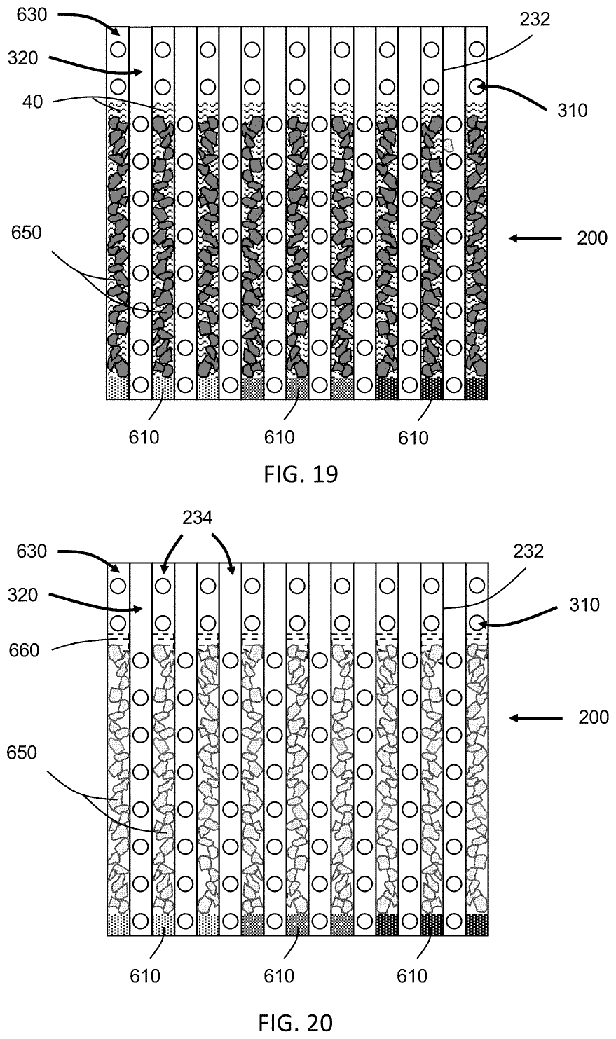

When the free-standing liquid begins to drain out, the liquid absorbing materials (650) that are exposed in the moisture channel (630) will start to release its absorbed liquid (40). The liquid (40) stored within the liquid absorbing materials (650) can be extracted by plant roots (22) or it can be redistributed in the form of water vapor to the growing medium (50) where it can condense as water when temperatures decrease and become available for plant uptake. The liquid absorbing materials (650) can re-hydrate and become saturated with liquid (40) following each watering, which can greatly reduce the frequency and quantity of water necessary to maintain optimal plant growth and productivity. The liquid absorbing materials (650) are preferable in a chunk or fragmented physical state, although other physical states can be utilized (e.g. sand, flakes). FIG. 19 shows a sectional view of the support wall (200), showing a plurality of moisture channels (630). Liquid absorbing materials (650) are contained within the moisture channels (630). The channel surfaces (232) of the moisture channels (630) also have aeration voids (310). Liquid permeable drain plugs (610) are inserted into the bottom channel opening (238). Liquid (40) is stored within the moisture channels (630).

The liquid absorbing materials (650) must be prepared and sieved before adding them into the moisture channels (630). A liquid permeable drain plug (610) is inserted in a channel opening (234), usually the bottom channel opening (238). Liquid absorbing materials (650) are added into the moisture channels (630) that are plugged with the liquid permeable drain plug (610). These moisture channels (630) with the added liquid absorbing materials (650) are sealed with a cover (660), preferably made from a water-soluble wax or similar material with water-soluble characteristics, to ensure the liquid absorbing materials (650) stay in place until the first watering. The cover (660) is placed on the opposite channel opening (234) from the liquid permeable drain plug (610). FIG. 20 shows a sectional view of the support wall (200), showing a plurality of moisture channels (630). Liquid absorbing materials (650) are contained within the moisture channels (630). The channel surfaces (232) of the moisture channels (630) also have aeration voids (30). Liquid permeable drain plugs (610) are inserted into the bottom channel openings (238). Covers (660) seal the channel openings (234) that contain liquid absorbing materials (650).

(7)(b) Liquid permeable drain platform

A liquid permeable drain platform (900) controls the amount and duration of water storage in the growing medium (50). A liquid permeable drain platform (900) may be used as a standalone device or in conjunction with the plant growing structure (100). As a standalone device, the liquid permeable drain platform (900) may be used with plant containers or for planting in the ground.

Current techniques for managing water in the plant root zone depend almost entirely on the physical properties of the growing medium (50) including the porosity, texture, and permeability rate. In most cases, the growing medium (50) developed for plant containers is optimized to promote rapid drainage and to increase aeration because containers restrict oxygen circulation in the root zone. As a result, much of the pore space in the growing medium (50) is unable to hold water for extended periods of time, requiring more frequent watering to meet the demands of the plant. In addition, most growing medium designed for plant containers is composed primarily of sphagnum peat moss and other organic materials making most growing medium (50) highly susceptible to becoming hydrophobic if it becomes too dry. When peat or growing medium becomes too dry, it tends to repel water making it difficult to thoroughly saturate the growing medium, especially after planting in the ground. Rehydrating the growing medium often requires the application of substantial amounts of water that far exceed the demands of the plant, increasing costs and time associated with watering plants in containers or recently planted in the ground.

The liquid permeable drain platform (900): i) reduces the amount of water required to thoroughly re-hydrate the growing medium after it becomes too dry or hydrophobic; ii) increases the water holding capacity of growing medium and its ability to supply plant available water for extended periods of time without changing the physical properties of the growing medium itself; iii) reduces water loss below the plant root zone by controlling infiltration rates near the bottom the root ball; iv) reduces water stress and increases drought tolerance; and v) promotes more uniform water distribution and soil moisture content throughout the entire volume of the root ball or excavation.

The liquid permeable drain platform (900) normally has a flat surface, with round, square or of any other suitable surface area geometry. The liquid permeable drain platform (900) can be used to cover objects, such as inside the bottom of a plant container (30). The liquid permeable drain platform (900) can also be used for objects to rest on, such as a plant (10) and its root ball, a plant container (30), or the plant growing structure (100).

The liquid permeable drain platform (900) is composed of the same materials that are used to make liquid permeable drain plugs (610).

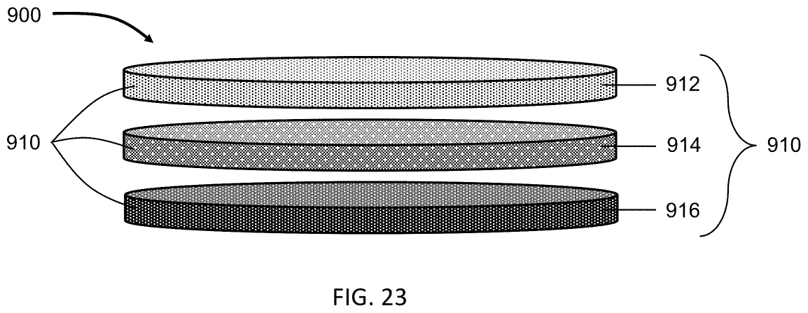

The liquid permeable drain platform (900) may have a single layer of material with a composition and consistency matching a preferred liquid flow rate. However, other embodiments of the liquid permeable drain platform (900) may have a plurality of layers (900), each layer (900) having discrete liquid permeability characteristics that allow for a preferred liquid flow rate. This feature is useful to adjust the preferred drainage rate of the plurality of layers. FIG. 23 shows a perspective exploded view of a liquid permeable drain platform (900) with a plurality of drain platform layers (900), comprising a first drain platform layer (912), a second drain platform layer (914), and a third drain platform layer (916).

When used in conjunction with plant growing structures (100), the liquid permeable drain platform (900) is placed under the channel openings (234) of the channels (230) that face the growing medium (50), usually the bottom channel openings (238); this creates moisture channels (630) when used in conjunction with liquid (40). In a typical configuration, the liquid permeable drain platform (900) is placed under the support walls (200) of the plant growing structure (100). The liquid permeable drain platform (900) controls the movement of liquid (40) from the channels (230) into the growing medium (50); it creates moisture channels (630). The liquid permeable drain platform (900) can also be used in conjunction with aeration channels (320), fertilizer channels (720), and pesticide channels (520); the liquid permeable drain platform (900) would be able to control the flow of liquid pesticide (520) and liquid fertilizer (710) in to the growing medium (50).

The liquid permeable drain platform (900) may have a single layer of material with a plurality of drain platform sub-areas (920), each drain platform sub-area (920) having a discrete composition and consistency matching a preferred liquid flow rate. The size, shape, and location of these drain platform sub-areas (920) are selected to achieve desired moisture properties within the growing medium (50). The size, shape, and location of these drain platform sub-areas (920) also are reflective of the shape of the plant growing structure (100) that lies over the liquid permeable drain platform (900).

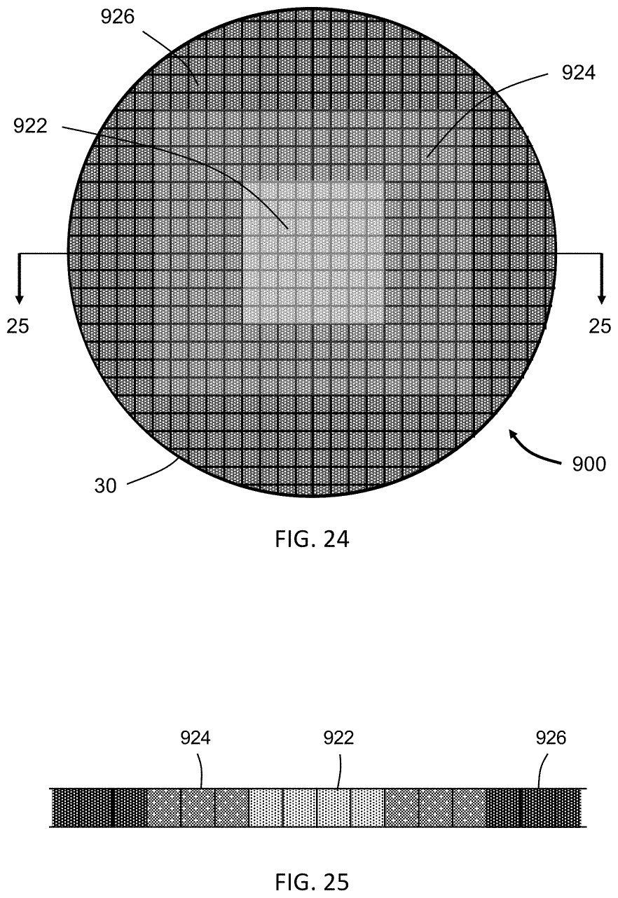

For example, drain platform sub-areas (920) may be concentric to one another, that is, sharing the same center. FIG. 24 shows a top view of a liquid permeable drain platform (900), where a first drain platform sub-area (922) is surrounded by a second drain platform sub-area (924) and a third drain platform sub-area (926). The first drain platform sub-area (922), second drain platform sub-area (924) and the third drain platform sub-area are concentric, sharing the same center. The inner perimeter of the second drain platform sub-area (924) and the third drain platform sub-area (926) are square shaped. The perimeter shapes of these drain platform sub-areas (920) may match the shape of the plant container (30) or the plant growing structure (100) that lies over the liquid permeable drain platform (900). FIG. 25 shows a sectional view of a liquid permeable drain platform (900) of FIG. 24 taken at the sectioning plane and in the direction indicated by section lines 25-25. The sectional view shows the first drain platform sub-area (922) surrounded by a second drain platform sub-area (924) and a third drain platform sub-area (926).

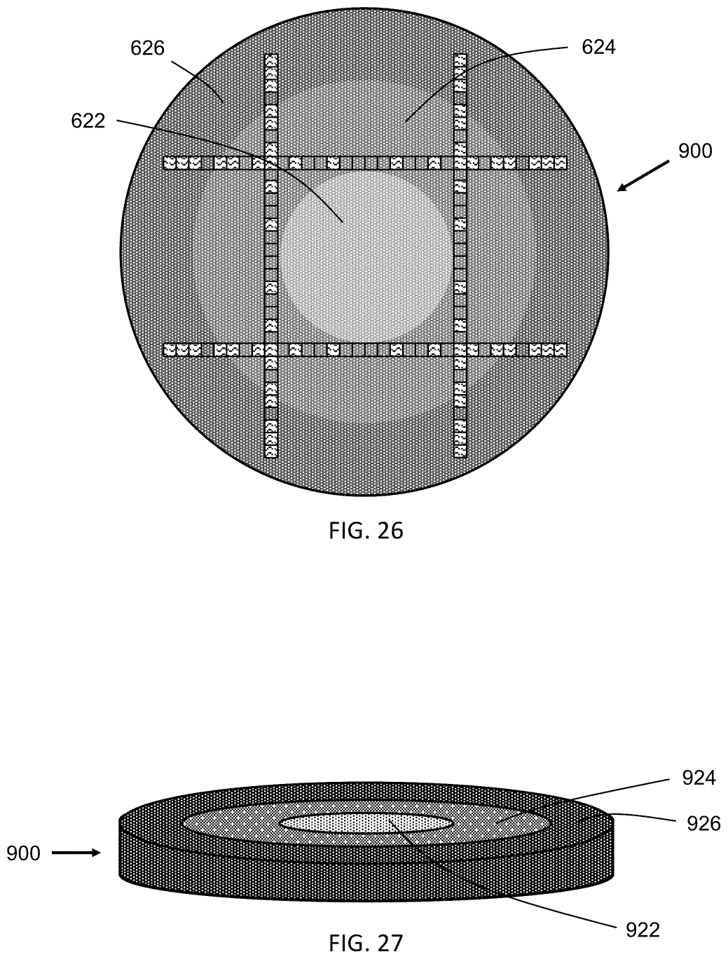

FIG. 26 shows a top view of a liquid permeable drain platform (900), where a first drain platform sub-area (922) is surrounded by a second drain platform sub-area (924) and a third drain platform sub-area (926). The first drain platform sub-area (922), second drain platform sub-area (924) and the third drain platform sub-area are concentric, sharing the same center. The inner perimeter of the second drain platform sub-area (924) and the third drain platform sub-area (926) are round shaped. The liquid permeable drain platform (900) is located under the plant growing structure (100).

FIG. 27 shows a perspective view of a liquid permeable drain platform (900), where a first drain platform sub-area (922) is surrounded by a second drain platform sub-area (924) and a third drain platform sub-area (926). The second drain platform sub-area (924) and the third drain platform sub-area are concentric to the center of the first drain platform sub-area (922). The inner perimeter of the second drain platform sub-area (924) and the third drain platform sub-area (926) are round shaped.

### (8) Fertilizer Structure

The Fertilizer Structure (700) is designed to provide targeted, point-source time-release fertilizer directly to the plant root system to increase nutrient uptake by the plant and to reduce fertilizer loss through pathways such as leaching and gaseous emissions.

The Fertilizer Structure (700) is designed to place time-release fertilizers in direct contact with the majority of the plant root system by using the structure itself as a physical barrier to direct and promote root growth throughout the internal and external surface area of the fertilizer structure.

The Fertilizer Structure (700) results in very high root-to-nutrient contact throughout the plant root system allowing the plant to acquire nutrients more efficiently than traditional methods. The fertilizer used can also be composed of substrates with high pH buffering capacity (calcium carbonate, calcium/magnesium carbonate, calcium hydroxide). This would have the effect of making nutrients already present in the soil available for plant uptake, as many micro-nutrients such as copper and zinc are present in the soil in sufficient quantities but are not available for plant uptake if the growing medium is too acidic or alkaline. Custom fertilizer structures can easily be produced to resolve specific nutrient deficiencies in plants by filling the Fertilizer Structure (700) with a concentrated time-release fertilizer of the nutrient(s) of interest.

The Fertilizer Structure (700) optimizes fertilizer content throughout the rooting zone by filling one or more of the fertilizer channels (720) within a support wall (200) with fertilizer (710).

The Fertilizer Structure (700) is prepared by adding fertilizer (7100) into a channel (230) of a support wall (200). A channel (230) that contains fertilizer (710) is called a fertilizer channel (720). There are one or more fertilizer channels (720) within a Fertilizer Structure (700). A fertilizer channel (720) can be prepared by overlaying the channel surface (232) of a fertilizer channel (720) with a layer of fertilizer (710)—the fertilizer (710) is layered over the channel surface (232). A fertilizer channel (720) may also be prepared by adding liquid, solid, or a gel formulation of the fertilizer (710) to a channel (230). When the fertilizer (710) is in a liquid, solid, or gel formulation, the fertilizer is held in place by a physical barrier, such as a liquid permeable structure (605) or a non liquid-permeable plug (612). Sample materials suitable for a non liquid-permeable plug (612) include silicone and rubber.

Once the liquid permeable drain plugs (610) have been inserted into a channel opening (234), the fertilizer channels (720) may be filled with liquid fertilizer (712), solid fertilizer (714), or gel fertilizer (716) or a combination thereof. The solid fertilizer (714) and the gel fertilizer (716) may have time-release characteristics. The solid fertilizer (714) can vary in consistency from a fine powder to large granules. The diameter of the aeration voids (310) in the support walls (200), as well as the number and distribution of aeration voids (310), must be specifically selected to ensure that the solid fertilizer (714) is retained while still allowing plant roots (22) to pass easily through the support walls (200). The gel fertilizer (716) may have dual state properties, that is, the gel fertilizer has minimal to no flow properties at or near room temperature but when heated, the gel fertilizer (716) acquires liquid properties. The dual state gel fertilizer (718) can be poured into the fertilizer channels (720) as a heated liquid, which then solidifies as it cools to room temperature. The properties of the dual state gel fertilizer (718) must be such that it can be easily poured when heated but remains in a solid state at temperatures below approximately 170° Fahrenheit to ensure the dual state gel fertilizer (718) remains within the plant growing structure (100) during shipping, transport, and storage.

The gel fertilizer (716) is also suitable to be layered over the channel surface (232) of a fertilizer channel (720).

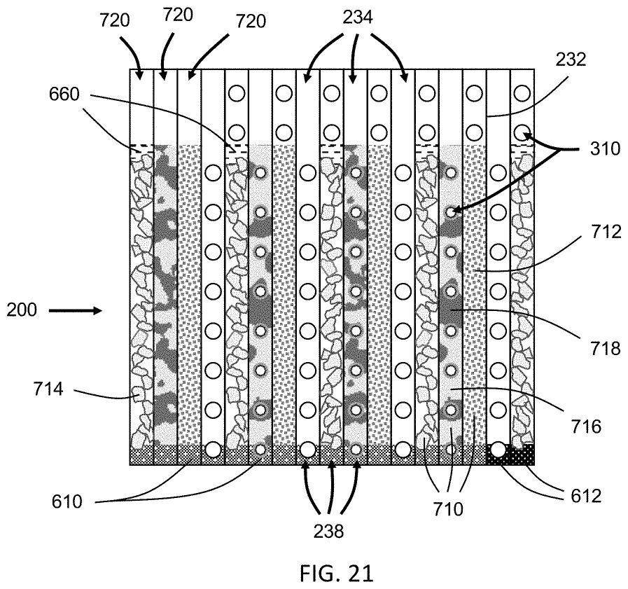

FIG. 21 shows a sectional view of the support wall (200), showing a plurality of fertilizer channels (720). Solid fertilizer (714) is contained within some of the fertilizer channels (720). Liquid fertilizer (712) is contained within some of the fertilizer channels (720). Gel fertilizer (716), specifically dual state gel fertilizer (718), is contained within some of the fertilizer channels (720). Some channel surfaces (232) of the fertilizer channels (720) have aeration voids (310). Liquid permeable drain plugs (610) are inserted into the bottom channel openings (238). Non liquid-permeable plugs (612) are also inserted into the bottom channel openings (238). Covers (660) seal the channel openings (234) that contain solid fertilizer (714).

If the Fertilizer Structure (700) is made from biodegradable materials, the function of the Fertilizer Structure (700) would continue after the Fertilizer Structure (700) has biodegraded and broken down since the fertilizer (710) would remain in place. For example, if a biodegradable plant growing structure (100) was filled with a solid fertilizer (716) such as rock phosphate or other time-release fertilizer, the solid fertilizer (716) would remain intact in the growing medium (50) within the plant container (30) or in the ground for up to several years after the biodegradable polymer plant growing structure (100) biodegrades.

### (9) Multi-Purpose Structure

The characteristics of the various above described channels may be combined into a multi-purpose structure (800). A plant growing structure (100) may have support walls (200) that comprise a combination of two or more types of the channels described above—aeration channels (320), moisture channels (630), pesticide channels (5200), biological channels (470), or fertilizer channels (720). The selection of the specific types of channels (230), their number, and their configuration within the support walls (200) would be determined by the specific nature of the planting issues that need to be addressed.

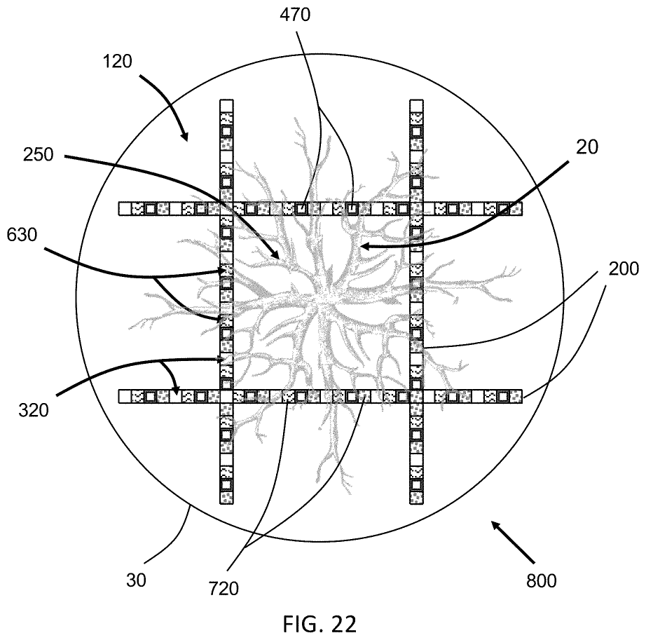

For example, a multi-purpose structure (800) may have aeration channels (320), moisture channels (630), and fertilizer channels (720) to address air circulation, moisture, and nutrition issues within a given growing medium (50). FIG. 22 is a cross sectional view of a standard lattice structure (120) within a plant container (30). The support walls (200) cross each other so that the cross sectional shape of the planting volume (250) of the standard lattice structure (120) is square. The plant roots (22) of the plant root system (20) are placed within the planting volume (250) of the standard lattice structure (220). The multi-purpose structure (800) has aeration channels (320), moisture channels (630), fertilizer channels (720), and biological channels (470).

### (10) Multi-Purpose Channels

The characteristics of the various above described channels (2300) may be combined into a multi-purpose channel (850), so a channel (230) may share the characteristics of two or more types of channels (230): aeration channels (320), moisture channels (630), pesticide channels (520), biological channels (470), or fertilizer channels (720). For example in FIG. 21, the support wall (200) has a channel (230) with aeration voids (310) and fertilizer (710)—aeration channel (320) plus fertilizer channel (720). In FIG. 15, the support wall (200) has a channel (230) with aeration voids (310) and substrate (410), microbial populations (430) and microbial colonies (432)—aeration channel (320) plus biological channel (470).

### (11) Multi-Purpose Channels and Multi-Purpose Structure

The characteristics of the Multi Purpose Structure (800) and the Multi-Purpose Channel (850) may be combined so that a support wall (200) may have a combination of two or more types of the channels described above and one or more channels (230) may share the characteristics of two or more types of channels (230).

### (12) Materials Used in the Patent

The plant growing structure may be constructed out of a wide variety of porous and non porous materials or materials that can be altered to create adequate porosity. These materials can include but are not limited to plastics, fabrics, wood products, synthetic rubber, plant products, biodegradable polymers, sponge-like materials, nanomaterials, time-release fertilizer materials, processed rock phosphate, calcined clay, animal manure, and farm waste products.

### (13) Clarifying Comments

While the foregoing written description of the invention enables a person having ordinary skill in the art to make and use what is considered presently to be the best mode thereof, those of ordinary skill in the art will understand and appreciate the existence of variations, combinations, and equivalents of the specific embodiment, process, and examples herein. The invention should therefore not be limited by the above described embodiment, process, and examples, but by all embodiments and processes within the scope and spirit of the invention.

I claim:

1. A plant growing structure that promotes the growth of plant roots in a growing medium, the plant growing structure comprising:
(A) a plurality of support walls, the support walls comprising:
i) a first outer layer;
ii) a second outer layer;
iii) an inner layer;
iv) where the inner layer joins the first outer layer with the second outer layer, and
v) an aeration channel, the aeration channel comprising:
a) an aeration channel surface; the aeration channel surface comprising: the surface of the first outer layer, the surface of the second outer layer; and the surface of the inner layer; and
b) an aeration hole;
c) where the aeration hole is located on the aeration channel surface;
(B) where the support walls are joined together.

2. The plant growing lattice structure of claim 1, wherein the support walls further comprising:
(A) a biological channel, the biological channel comprising:
i) a biological channel surface; the biological channel surface comprising:
a) the surface of the first outer layer; the surface of the second outer layer; and the surface of the inner layer; and
ii) a substrate, the substrate comprising of:
a) nutrients; and
b) a microbial population;
iii) where the substrate is layered over the biological channel surface.

3. The plant growing structure of claim 2, wherein the substrate further comprising:
(A) a microbial colony.

4. The plant growing structure of claim 1, wherein the support walls further comprising:
(A) a pesticide channel, the pesticide channel comprising:
i) pesticide;
ii) where the pesticide is contained within the pesticide channel.

5. The plant growing structure of claim 4, wherein the pesticide channel further comprising:
(A) a top pesticide channel opening;
(B) a bottom pesticide channel opening; and
(C) a liquid permeable drain plug;
(D) where the bottom pesticide channel opening faces the growing medium,
(E) where the liquid permeable drain plug is inserted into the bottom pesticide channel opening,
(F) where the pesticide is a solid,
(G) where the pesticide is contained within the pesticide channel by the liquid permeable drain plug.

6. The plant growing structure of claim 5, wherein the pesticide channel further comprising:
(A) a non liquid-permeable plug;
(B) where the non liquid-permeable plug is inserted into the bottom pesticide channel opening.

7. The plant growing structure of claim 4, wherein the pesticide channel further comprising:
(A) a pesticide channel surface; the pesticide channel surface comprising:
i) the surface of the first outer layer; the surface of the second outer layer; and the surface of the inner layer;
ii) where the pesticide is layered over the pesticide channel surface.

8. The plant growing structure of claim 1, wherein the support walls further comprising:
(A) a fertilizer channel; the fertilizer channel comprising:
i) fertilizer;
ii) where the fertilizer is contained within the fertilizer channel.

9. The plant growing structure of claim 8, wherein the fertilizer channel further comprising:
(A) a top fertilizer channel opening;
(B) a bottom fertilizer channel opening; and
(C) a liquid permeable drain plug;
(D) where the bottom fertilizer channel opening faces the growing medium,
(E) where the liquid permeable drain plug is inserted into the bottom fertilizer channel opening,
(F) where the fertilizer is a liquid,
(G) where the fertilizer is contained within the fertilizer channel by the liquid permeable drain plug.

10. The plant growing structure of claim 8, wherein the fertilizer channel comprising:
(A) a top fertilizer channel opening;
(B) a bottom fertilizer channel opening; and
(C) a liquid permeable drain plug;
(D) where the bottom fertilizer channel opening faces the growing medium,
(E) where the liquid permeable drain plug is inserted into the bottom fertilizer channel opening,
(F) where the fertilizer is a solid,
(G) where the fertilizer is contained within the fertilizer channel by the liquid permeable drain plug.

11. The plant growing structure of claim 8, wherein each fertilizer channel further comprising:
(A) a fertilizer channel surface; the fertilizer channel structure comprising:
i) the surface of the first outer layer; the surface of the second outer layer; and the surface of the inner layer;
(B) where the fertilizer is a gel,
(C) where the fertilizer is layered over the fertilizer channel surface.

12. The plant growing structure of claim 1, wherein the support walls further comprising:
(A) a moisture channel, the moisture channel comprising:
i) a top moisture channel opening;
ii) a bottom moisture channel opening; and
iii) a liquid permeable drain plug;
iv) where the bottom moisture channel opening faces the growing medium,
v) where the liquid permeable drain plug is inserted into the bottom moisture channel opening.

13. The plant growing structure of claim 12, wherein the moisture channel further comprising:
(A) liquid absorbing material;
(B) where the liquid absorbing material is contained within the moisture channel by the liquid permeable drain plug.

14. The plant growing structure of claim 1,
(A) the plant growing structure further comprising:
i) a liquid permeable drain platform;
(B) wherein the support walls further comprising: a moisture channel, the moisture channel comprising:
i) a top moisture channel opening; and
ii) a bottom moisture channel opening;
(C) where the bottom moisture channel opening faces the growing medium,
(D) where the liquid permeable drain platform is placed under the bottom moisture channel opening.

15. The plant growing structure of claim 14, wherein the liquid permeable drain platform further comprising:
(A) a plurality of drain platform sub-areas;
(B) where each drain platform sub-area is made from materials with discrete liquid permeable properties.

16. The plant growing structure of claim 15,
(A) where the drain platform sub-areas are concentric to one another.

17. The plant growing structure of claim 14, wherein the liquid permeable drain platform further comprising:
(A) a plurality of drain platform layers;
(B) where each drain platform layer is made from materials with discrete liquid permeable properties.

18. A liquid permeable drain platform that controls the amount and duration of water storage in a growing medium, the liquid permeable drain platform comprising:
(A) a plurality of drain platform sub-areas;
(B) where each drain platform sub-area is made from materials with discrete liquid permeable properties.

19. The plant growing structure of claim 18,
(A) where the drain platform sub-areas are concentric to one another.

20. A multi-purpose plant growing structure that promotes the growth of plant roots in a growing medium, the multi-purpose plant growing structure comprising:
(A) a plurality of support walls, the support walls comprising:
i) a first outer layer;
ii) a second outer layer;
iii) an inner layer;
iv) where the inner layer joins the first outer layer with the second outer layer, and
v) a channel selected from the group consisting of an aeration channel, a biological channel, a pesticide channel, a moisture channel, and a fertilizer channel;
(B) where the support walls are joined together.
